(19) United States
(12) Patent Application Publication
(10) Pub. No.: US 2018/0126470 A1
(43) Pub. Date: May 10, 2018

(54) BLADE CLAMP FOR A RECIPROCATING POWER TOOL

(71) Applicant: MILWAUKEE ELECTRIC TOOL CORPORATION, Brookfield, WI (US)

(72) Inventor: Hans T. Banholzer, Milwaukee, WI (US)

(21) Appl. No.: 15/809,125

(22) Filed: Nov. 10, 2017

Related U.S. Application Data
(60) Provisional application No. 62/420,007, filed on Nov. 10, 2016.

(51) Int. Cl. B23D 51/10; B23D 49/16

(52) U.S. Cl. CPC B23D 51/10; B23D 49/162

(57) ABSTRACT

A blade clamp for removably coupling a saw blade to a spindle of a reciprocating power tool includes an actuator rotatable about the spindle and a locking member movable relative to the spindle between a locking position and a release position in response to rotation of the actuator. The locking member has a first section defining a first diameter that is constant along a length of the first section. The locking member has a second section adjacent the first section and defining a second diameter that decreases along a length of the second section. The locking member has a third section adjacent the second section and defining a third diameter that is constant along a length of the third section. The third section of the locking member is engageable with the saw blade to couple the saw blade to the spindle when the locking member is in the locking position.

### CROSS-REFERENCE TO RELATED APPLICATIONS

This application claims priority to co-pending U.S. Provisional Patent Application No. 62/420,007, filed on Nov. 10, 2016, the entire content of which is incorporated herein by reference.

### FIELD OF THE INVENTION

The present invention relates to reciprocating power tools, and more particularly to blade clamps for quickly and easily replacing and securing a saw blade to a spindle of a reciprocating saw.

### BACKGROUND OF THE INVENTION

Reciprocating tools, such as reciprocating saws, include removable blades to permit the use of different types of blades and to allow for replacement of worn or damaged blades. Accordingly, reciprocating saws typically include a blade mounting system that allows for blade replacement while securely coupling the blade to the tool.

### SUMMARY OF THE INVENTION

The present invention provides, in one aspect, a blade clamp for removably coupling a saw blade to a spindle of a reciprocating power tool. The blade clamp includes an actuator rotatable about the spindle and a locking member movable relative to the spindle between a locking position and a release position in response to rotation of the actuator. The locking member has a first section defining a first diameter that is constant along a length of the first section. The locking member also has a second section adjacent the first section and defining a second diameter that decreases along a length of the second section. The locking member also has a third section adjacent the second section and defining a third diameter that is constant along a length of the third section. The third section of the locking member is engageable with the saw blade to couple the saw blade to the spindle when the locking member is in the locking position.

The present invention provides, in another aspect, a reciprocating power tool including a spindle with a slot configured to receive a saw blade and a blade clamp configured to removably couple the saw blade to the spindle. The blade clamp includes a locking member movable relative to the spindle between a locking position in which the locking member extends into the slot and a release position in which the locking member is retracted from the slot. The locking member has a first section with a generally cylindrical shape a second section extending from the first section with a generally frustoconical shape, and a third section extending from the second section with a generally cylindrical shape. The third section of the locking member is engageable with the saw blade to couple the saw blade to the spindle when the locking member is in the locking position.

The present invention provides, in another aspect, a locking member selectively engageable with a saw blade to couple the saw blade to a spindle of a reciprocating power tool. The locking member includes a first section defining a first diameter that is constant along a length of the first section, a second section extending from the first section, the second section defining a second diameter that decreases along a length of the second section, and a third section extending from the second section to an end of the locking member, the third section defining a third diameter this is constant along a length of the third section.

Other features and aspects of the invention will become apparent by consideration of the following detailed description and accompanying drawings.

### BRIEF DESCRIPTION OF THE DRAWINGS

FIG. 1 is a side view of a reciprocating power tool including a blade clamp according to an embodiment of the invention.

FIG. 2 is a perspective view of a spindle and the blade clamp of the reciprocating power tool shown in FIG. 1.

FIG. 3 is cross-sectional view of the spindle and the blade clamp shown in FIG. 2.

FIG. 4 is a perspective view of a pin of the blade clamp.

FIG. 5 is a side view of the pin of FIG. 4.

FIG. 6 is a cross-sectional view of the pin of FIG. 4 received in an aperture of a blade.

FIG. 7 is an exploded view of the spindle and the blade clamp of FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

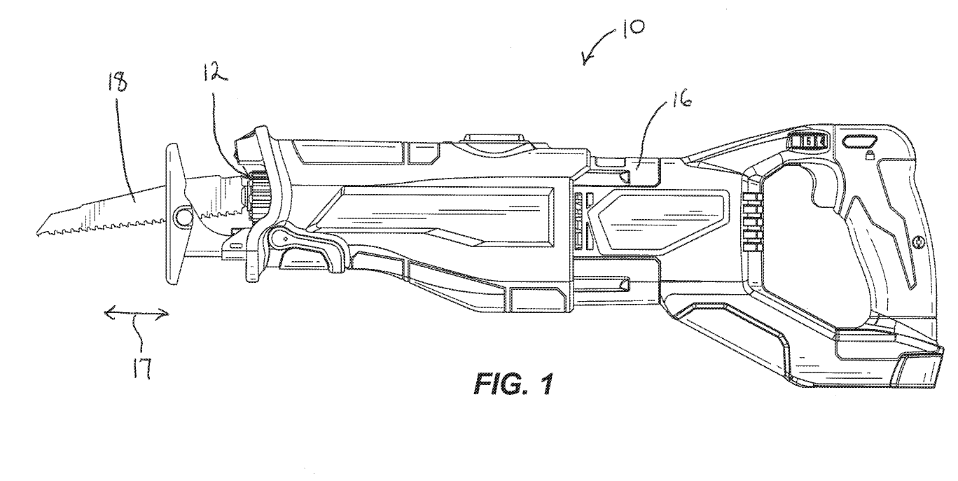

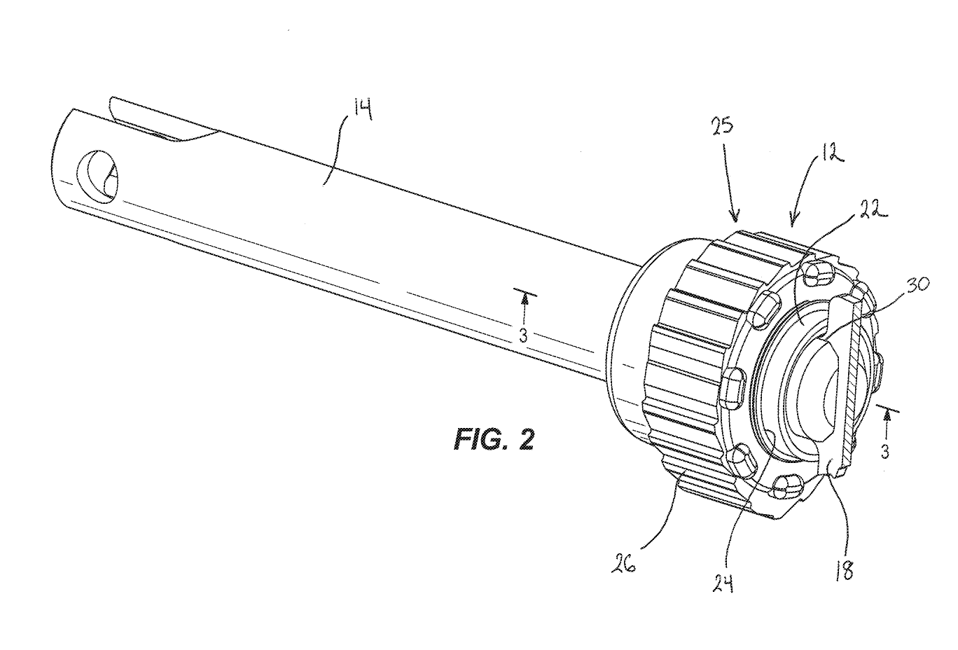

FIG. 1 illustrates a reciprocating power tool 10 including a blade clamp 12 according to one embodiment of the invention. The illustrated reciprocating power tool is a reciprocating saw 10. However, in other embodiments, other reciprocating power tools may include the blade clamp 12 described below. Referring to FIGS. 1 and 2, the saw 10 includes a spindle 14 and a housing 16. The spindle 14 is reciprocated in the direction of arrows 17 relative to the housing 16 by the saw 10. The blade clamp 12 couples a blade 18 to the spindle 14 so that the blade 18 reciprocates with the spindle 14. The blade clamp 12 also allows a user to remove and replace the blade 18.

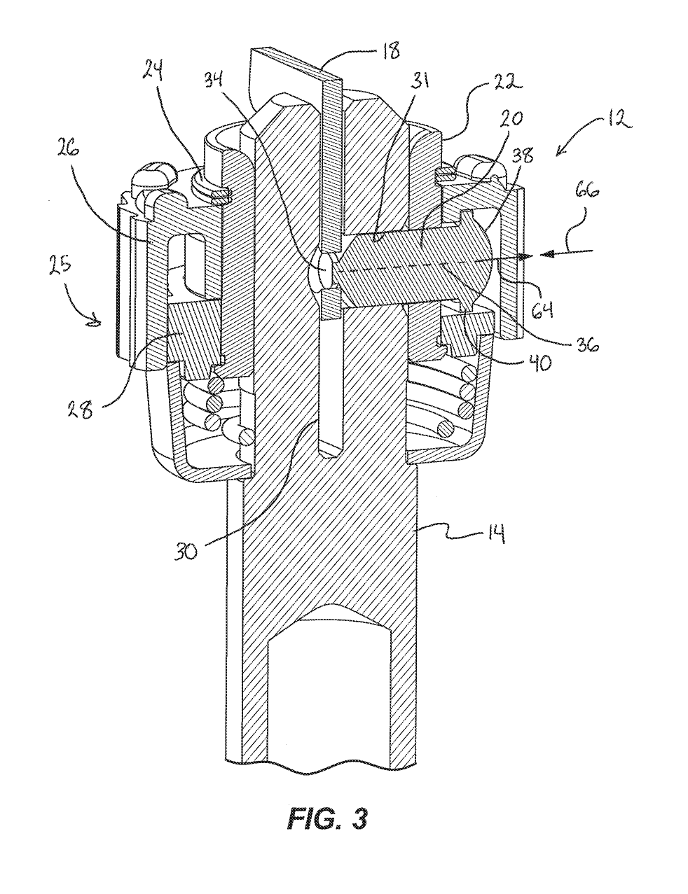

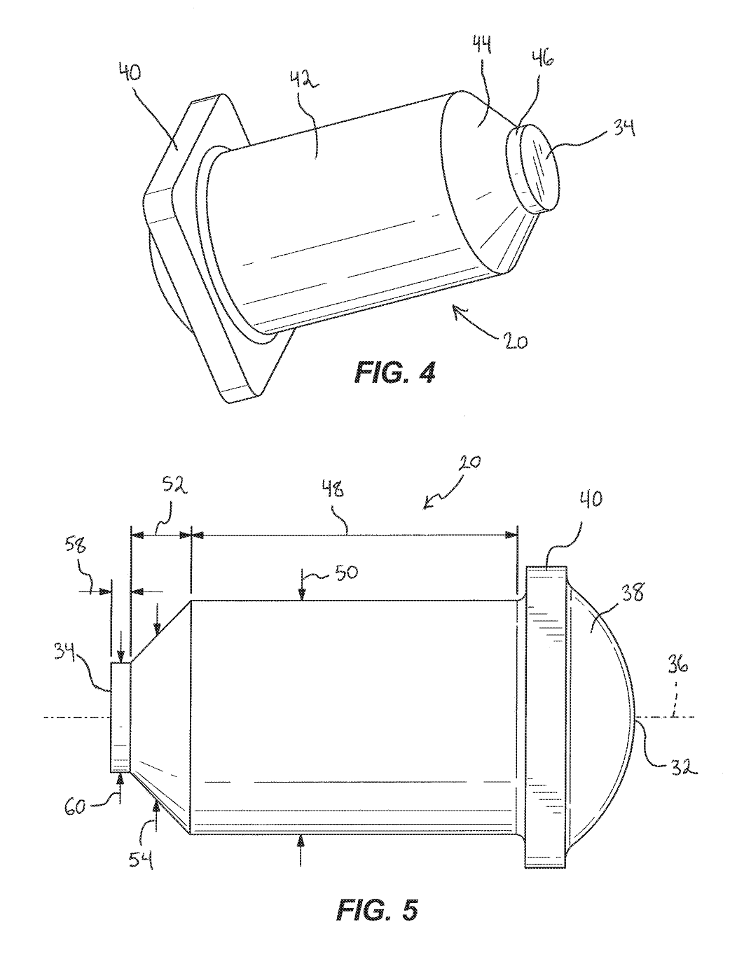

Referring to FIG. 3, the blade clamp 12 includes a locking member or pin 20, a sleeve 22, a retaining ring 24, and an actuator 25. In the illustrated embodiment, the actuator 25 includes a first cam 26, and a second cam 28. The sleeve 22 couples the blade clamp 12 to the spindle 14 via the pin 20. The retaining ring 24 couples the actuator 25 to the sleeve 22 such that the actuator 25 is rotatable relative to the sleeve 22 and around the spindle 14. The spindle 14 includes a longitudinally-extending slot 30 and an aperture 31 that extends into the slot 30. As will be discussed in more detail below, the pin 20 is linearly movable along the aperture 31 between a locking position (FIG. 3) in which the pin 20 projects into the slot 30 to couple the blade 18 to the spindle 14 and a release position in which the pin 20 is retracted from the slot 30 to permit removal of the blade 18.

Referring to FIG. 5, the pin 20 includes a first end 32, a second end 34, and a longitudinal axis 36 that extends centrally through the pin 20 and through the ends 32 and 34. The pin 20 includes a rounded head 38 at the first end 32 and a flange 40 adjacent the rounded head 38. In the illustrated embodiment, the flange 40 has a generally square cross-sectional shape. In other embodiments, the flange 40 can have other non-circular cross-sectional shapes or a circular cross-sectional shape. Alternatively, the pin 20 may not include the flange 40 in some embodiments. Between the first end 32 and the second end 34 (and, in the illustrated embodiment, between the flange 40 and the second end 34), the pin 20 includes a first section 42, a second section 44 adjacent the first section 42, and a third section 46 adjacent the second section 44. The first section 42 extends from the flange 40 a length 48 measured parallel to the longitudinal axis 36 of the pin 20. The illustrated first section 42 is generally cylindrical and defines a diameter 50 measured normal to the axis 36. In the illustrated embodiment, the diameter 50 is constant along substantially the entire length 48 of the first section 42. In other embodiments, the first section 42 can have other cross-sectional shapes, such as square, rectangular, oval etc. However, the outer dimension, the diameter 50 in the illustrated embodiment, is preferably constant regardless of the cross-sectional shape.

The second section 44 of the pin 20 extends from the first section 42 opposite the flange 40. The second section 44 extends from the first section 42 a length 52 measured parallel to the axis 36. The length 52 of the second section 44 is less than the length 48 of the first section 42. The illustrated second section 44 has a generally frustoconical shape with a diameter 54 measured normal to the axis 36. As such, the diameter 54 of the second section 44 in the illustrated embodiment decreases at constant rate in a direction from the first section 42 toward the third section 46 of the pin 20 along the axis 36. In other embodiments, the second section 44 can have other cross-sectional shapes, such as square, rectangular, oval etc. However, the outer dimension, (i.e. the diameter 54 in the illustrated embodiment), generally decreases at a constant rate regardless of the cross-sectional shape. In other embodiments, the outer dimension 54 of the second section 44 can decrease at a variable rate in a direction from the first section 42 toward the third section 46 of the pin 20 along the axis 36. For example, the second section 44 may have a curved or segmented profile that generally tapers inward from the first section 42 toward the third section 46.

With continued reference to FIG. 5, the third section 46 of the pin 20 extends from the second section 44 opposite the first section 42. The third section 46 extends from the second section 44 a length 58 measured parallel to the axis 36. In the illustrated embodiment, the length 58 of the third section 46 preferably less than the length 52 of the second section 44; however, in other embodiments, the length 58 of the third section 46 may be equal to or greater than the length 52 of the second section 44. The illustrated third section 46 is generally cylindrical and defines diameter 60 measured normal to the axis 36. In the illustrated embodiment, the diameter 60 is constant along substantially the entire length 58 of the third section 46. In other embodiments, the third section 46 can have other cross-sectional shapes, such as square, rectangular, oval etc. However, the outer dimension, (i.e. the diameter 60 in the illustrated embodiment), is preferably constant regardless of the cross-sectional shape.

Referring to FIG. 3, to remove the blade 18 from the slot 30 in the spindle 14, the user rotates the first cam 26 around the spindle 14. This rotation causes the second cam 28 to also rotate, which causes the first cam 26 and the second cam 28 to push the flange 40 of the pin 20 in the direction of arrow 64 in FIG. 3. This causes the pin 20 to move in the direction of arrow 64 and retract out of the slot 30 to the release position, allowing the user to remove the blade 18. In some embodiments, the user may pull on the blade 18, and the blade 18 will bear against the second section 44 of the pin 20 and manually push the pin 20 in the direction of arrow 64 to permit removal of the blade 18.

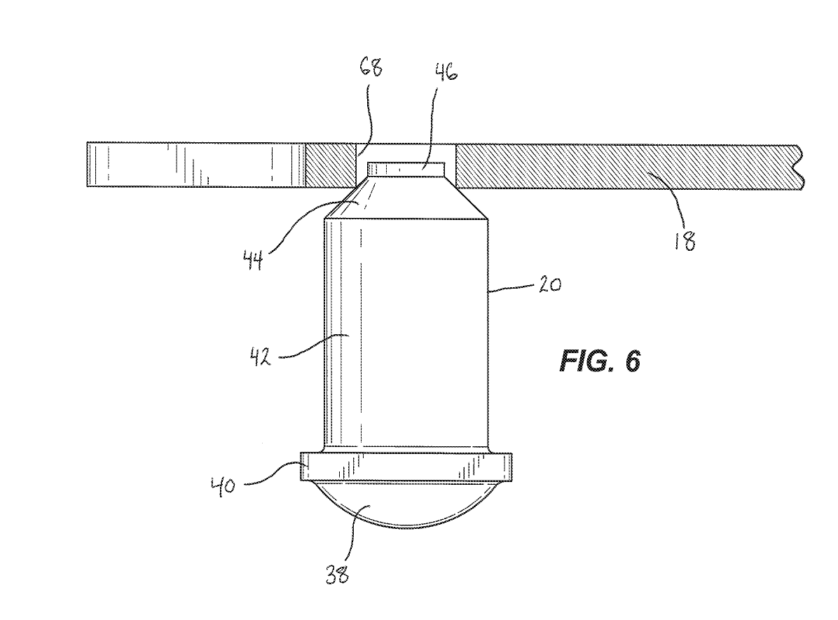

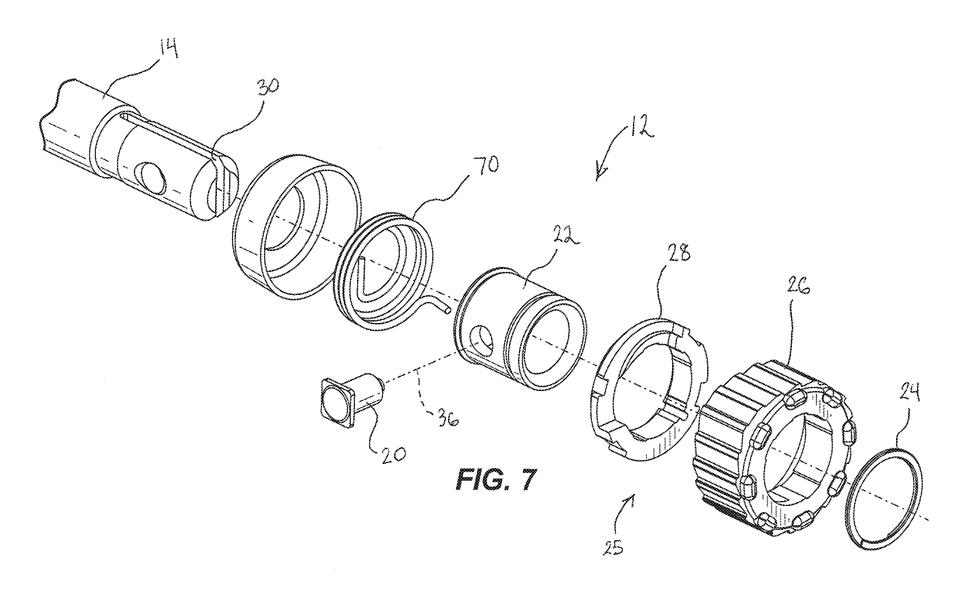

With the pin 20 out of the slot 30, the user inserts a new blade 18 and releases the first cam 26. A spring 70 (FIG. 7), which is a torsion spring in the illustrated embodiment, automatically rotates the second cam 28 around the spindle 14. This rotation causes the first cam 26 to push on the head 38 of the pin 20, which pushes the pin 20 in the direction of arrow 66 in FIG. 3. Movement of the pin 20 in the direction of arrow 66 moves the pin 20 back into the slot 30 to the locking position (FIGS. 3 and 6). With the blade 18 in the slot 30, the third section 46 and at least a portion of the second section 44 of the pin 20 are received in an aperture 68 (FIG. 6) of the blade 18 and engageable with the blade 18 to couple the blade 18 to the spindle 14 for use with the saw 10.

The constant diameter 60 of the third section 46 of the pin 20 advantageously provides a more secure attachment of the blade 18 to the spindle 14. The attachment is stronger and able to better withstand forces during use of the saw 10 that tend to pull the blade 18 out of the slot 30 in the spindle 14. Accordingly, the blade clamp 12 allows the user to quickly and easily replace the blade 18 without the use of tools such as wrenches, screwdrivers, etc. and yet the blade 18 is firmly held in position by the clamp 12 including the pin 20.

Various features of the invention are set forth in the following claims.

What is claimed is:

1. A blade clamp for removably coupling a saw blade to a spindle of a reciprocating power tool, the blade clamp comprising:
an actuator rotatable about the spindle; and
a locking member movable relative to the spindle between a locking position and a release position in response to rotation of the actuator, the locking member including
a first section defining a first diameter that is constant along a length of the first section,
a second section adjacent the first section and defining a second diameter that decreases along a length of the second section, and
a third section adjacent the second section and defining a third diameter that is constant along a length of the third section,
wherein the third section of the locking member is engageable with the saw blade to couple the saw blade to the spindle when the locking member is in the locking position.

2. The blade clamp of claim 1, wherein the locking member includes a first end, a second end opposite the first end, and a rounded head at the first end.

3. The blade clamp of claim 2, wherein the third section extends from the second end to the second section.

4. The blade clamp of claim 2, wherein the locking member includes a flange adjacent the rounded head, and wherein the first section extends from the flange to the second section.

5. The blade clamp of claim 1, wherein the second section is generally frustoconical.

6. The blade clamp of claim 1, wherein the third section is generally cylindrical.

7. The blade clamp of claim 1, wherein the actuator includes a first cam and a second cam.

8. The blade clamp of claim 1, wherein the second diameter decreases along the length of the second section at a constant rate.

9. The blade clamp of claim 1, wherein the locking member is linearly movable between the locking position and the release position.

10. The blade clamp of claim 1, wherein the length of the second section is less than the length of the first section.

11. The blade clamp of claim 1, wherein the length of the third section is less than the length of the second section.

12. A reciprocating power tool comprising:
a spindle including a slot configured to receive a saw blade;
a blade clamp configured to removably couple the saw blade to the spindle, the blade clamp including a locking member movable relative to the spindle between a locking position in which the locking member extends into the slot and a release position in which the locking member is retracted from the slot, the locking member including
a first section having a generally cylindrical shape
a second section extending from the first section and having a generally frustoconical shape, and
a third section extending from the second section and having a generally cylindrical shape,
wherein the third section of the locking member is engageable with the saw blade to couple the saw blade to the spindle when the locking member is in the locking position.

13. The reciprocating power tool of claim 12, wherein at least a portion of the second section is engageable with the saw blade when the locking member is in the locking position.

14. The reciprocating power tool of claim 12, wherein the first section defines a first diameter that is constant along a length of the first section, wherein the second section defines a second diameter that decreases along a length of the second section, and wherein the third section defines a third diameter that is constant along a length of the third section.

15. The reciprocating power tool of claim 14, wherein the second diameter decreases along the length of the second section at a constant rate.

16. The reciprocating power tool of claim 14, further comprising an actuator rotatably coupled to the spindle, wherein the locking member is movable between the locking position and the release position in response to rotation of the actuator.

17. The reciprocating power tool of claim 14, wherein the length of the second section is less than the length of the first section, and wherein the length of the third section is less than the length of the second section.

18. A locking member selectively engageable with a saw blade to couple the saw blade to a spindle of a reciprocating power tool, the locking member comprising:
a first section defining a first diameter that is constant along a length of the first section;
a second section extending from the first section, the second section defining a second diameter that decreases along a length of the second section; and
a third section extending from the second section to an end of the locking member, the third section defining a third diameter this is constant along a length of the third section.

19. The locking member of claim 18, wherein the second diameter decreases at a constant rate along the length of the second section.

20. The locking member of claim 18, wherein the length of the second section is less than the length of the first section, and wherein the length of the third section is less than the length of the second section.
